(19) United States
(12) Patent Application Publication
(10) Pub. No.: US 2015/0177072 A1
(43) Pub. Date: Jun. 25, 2015

(54) INFRARED TEMPERATURE MAGNET WITH RFID ANTENNA

(71) Applicant: Aktiebolaget SKF, Goteborg (SE)

(72) Inventors: Jonathan D. Murphy, Friday Harbor, WA (US); Bryan Leslie Calderwood, Murrieta, CA (US)

(73) Assignee: Aktiebolaget SKF, Goteborg (SE)

(21) Appl. No.: 14/136,643

(22) Filed: Dec. 20, 2013

(51) Int. Cl. G01K 1/02; G01J 5/02

(52) U.S. Cl. CPC G01K 1/024; G01J 5/02

(57) ABSTRACT

A sensory head for sensing the temperature and vibration emitted from a machine housing having an RFID tag disposed thereon is provided. The sensory head includes a body for housing the sensory head and at least one digital input/output power contact. The sensory head further provides a combination power and control circuit for powering and for controlling function of the sensory head, the combination power and control circuit electrically connected to the at least one contact and an infrared temperature sensor for measuring the sensed temperature of the machine housing, the infrared temperature sensor in electrical communication with the combination power and control circuit. Finally, the sensory head provides an RFID antenna for reading and identifying the RFID tag attached to the machine housing, the RFID antenna electrically connected with the with the combination power and control circuit and at least one magnet.

### FIELD OF THE INVENTION

The present disclosure generally relates to an infrared temperature magnet. More particularly, the present disclosure relates to an infrared temperature magnet having an RFID antenna.

### BACKGROUND OF THE INVENTION

Data collection is a complicated and expensive effort. The data collecting devices are expensive, too big to put in a pocket and require significant training to use. Data collection usually involves several button presses and complex screens per each measurement taken.

Data is often collected to monitor the operation of industrial machines. Such data collection may be used to diagnose problems, troubleshoot, trend operating changes, or otherwise record data points indicative of machine operation. A variety of data types may be collected, including temperature, vibration, and the like. The data collection may be continuous, i.e., using dedicated resources for individual machines or groups of machines. In other cases, data collection may be on-demand, for example, in routine checking and maintenance of the machines. In the latter case, mobile units may be provided that use sensors that are either permanently or temporarily coupled with the machine being measured.

Such on-demand data collection may, however, be costly in terms of time and resources. For example, if several machines are being checked using a mobile unit, complexity in the operation of the data collection unit may be multiplied and may require significant time allocation. Further, bulkiness of such units may hinder movement between machines being measured. However, a reduction in unit size may reduce functionality, such as the ability to retain measurements from previous operations, execute data collection/management software, etc. Complexity may also introduce the possibility of human error, and thus resources may be expended in training users to operate the units.

Furthermore, with mobile units, since they may capture data about several different machines in a session, care must be taken to establish the correct operating conditions to be monitored, associated with the correct machine, and with the correct operating constraints applied thereto, etc. Typically, this requires significant investments in training personnel responsible for collecting the data using the mobile units, and in software to manage the collected data and minimize error.

### SUMMARY OF THE INVENTION

Embodiments of the disclosure may provide a sensory head for sensing the temperature and vibration emitted from a machine housing having an RFID tag disposed thereon. The sensory head provides a body for housing the sensory head, at least one digital input/output power contact for delivering power to the sensory head and for providing at least one of a digital Input signal into the device and a digital output signal out of the sensory head. The sensory head further provides a combination power and control circuit 50 for powering the control circuit and for controlling function of the sensory head 100, the combination power and control circuit 50 in electrical communication with the at least one contact 10 and an infrared temperature sensor 120 for measuring the sensed temperature of the machine housing, the infrared temperature sensor 120 in electrical communication with the combination power and control circuit 50. Finally, the sensory head provides an RFID antenna 110 for reading and identifying the RFID tag attached to the machine housing, the RFID antenna 110 electrically connected with the with the combination power and control circuit 50 and at least one magnet 80 for magnetically attaching the sensory head 100 to the machine housing. As such, the transmission of machinery vibration from the machine housing through the sensory head is enabled when the sensory head is magnetically attached to the machine housing and the infrared temperature sensor takes a temperature measurement of the machine housing when the sensory head is installed proximate to the RFID tag.

In a first aspect of the present invention the sensory head may include the body having a threaded stud for mounting the device.

In a second aspect of the present invention the sensory head may further include a system ground connection integrated into the mounting stud.

In another aspect of the present invention the sensory head may have at least one mounting foot that transmits the magnetic flux emitted from the at least one magnet to the machine housing. Here, the magnetic foot is fabricated from a high permeability material.

In another aspect of the present invention the sensory head also includes the RFID antenna having one of an RFID spiral antenna or a wound inductor antenna mounted on an antenna plate.

In another aspect of the present invention the sensory head provides at least one RFID antenna connection that connects the RFID antenna through antenna plate to the combination power and control circuit.

In another aspect of the present invention the sensory head may further provide that the antenna 110 and mounting plate 70 are covered with a resin that protects and secures the antenna with the sensory head, the resin not extending beyond a base of the device body.

In another aspect of the present invention the sensory head may be arranged such that the infrared temperature sensor has a hood that shields the infrared temperature sensor.

In another aspect of the present invention the sensory head may include an infrared/antenna spacer for mounting and locating the infrared sensor and sensor hood within the device body.

In another aspect of the present invention the sensory head may have at least one digital input, digital output and power contact that further has three semi-circular contact rings and an isolator body, the isolator body separating the three semi-circular contact rings from coming into contact with each other, the isolator body and three semi-circular rings being potted with a resin.

In another aspect of the present invention the sensory head may be designed to have the device ground electrically connected with the printed circuit board.

In another aspect of the present invention the sensory head having the at least one magnet may further provide two magnets that insert into slots disposed within the printed circuit board.

In another aspect of the present invention the sensory head may provide the machine housing further including a bearing housing.

Embodiments of the disclosure may provide a sensory head in electro-mechanical communication with a mobile data collector, the sensory head for sensing the temperature of a machine housing having an RFID tag disposed thereon. Here, the temperature sensory head provides a body for housing the device, the body having a threaded recess for mounting, the threaded recess for providing electro mechanical communication to and from the device and a digital input/output power contact for delivering power to the device and for providing digital I/O signal communication into and out of the device. The sensory head also has a combination power and control circuit for powering the control circuit and for controlling function of the device and an infrared temperature sensor for measuring the sensed temperature of the machine or bearing housing. Additionally, an RFID antenna for reading and identifying the RFID tag is attached to the machine or bearing housing and a magnet for magnetically attaching the device to the machine or bearing housing. Here, the mobile data collector has a threaded stud for mounting the threaded recess of the temperature sensory head to the mobile data collector and when the device is installed proximate the RFID tag the device initiates an infrared sensor measurement of the bearing housing and transmits the measurement back to the mobile data collector for processing.

Embodiments of the disclosure may provide a temperature and vibration sensing system including a sensory head in electro-mechanical communication with a mobile data collector, the sensory head for sensing the temperature of and vibration emitted from a machine housing having an RFID tag disposed thereon. The sensory head having a body for housing the device, the body having a threaded recess for mounting, the threaded recess for providing electro mechanical communication to and from the device and a digital input/output power contact for delivering power to the device and for providing digital I/O signal communication into and out of the device; a combination power and control circuit for powering the control circuit and for controlling function of the device; an infrared temperature sensor for measuring the sensed temperature of the machine or bearing housing; an RFID antenna for reading and identifying the RFID tag attached to the machine or bearing housing; a magnet for magnetically attaching the device to the machine or bearing housing; the mobile data collector providing: a threaded stud for mounting the threaded recess of the temperature sensory head to the mobile data collector; and when the device is installed proximate the RFID tag the device initiates an infrared sensor measurement of the bearing housing and transmits the measurement back to the mobile data collector for processing.

In a final aspect of the temperature and vibration sensing system including a sensory head in electro-mechanical communication with a mobile data collector the at least one contact ring may further provide four semi-circular contact rings, and wherein the four contact rings support electrical communication for the power, the digital input/output and an antenna.

These and other advantages of the invention will be further understood and appreciated by those skilled in the art by reference to the following written specification, claims and appended drawings.

### BRIEF DESCRIPTION OF THE DRAWINGS

The invention will now be described, by way of example, with reference to the accompanying drawings, in which:

FIG. 1 is a perspective view of a sensing system according to a preferred embodiment of the present invention;

FIG. 2 is an elevated exploded view of sensory head according to a preferred embodiment of the present invention;

FIG. 3 is an elevated perspective view of a contact according to a preferred embodiment of the present invention;

FIG. 4 is an elevated perspective view of an isolator body according to a preferred embodiment of the present invention;

FIG. 5 is an elevated perspective view of a body shell according to a preferred embodiment of the present invention;

FIG. 6 is an elevated perspective view of printed circuit board according to a preferred embodiment of the present invention;

FIG. 7 is an elevated perspective view of an infrared temperature sensor according to a preferred embodiment of the present invention;

FIG. 8 is an elevated perspective view of a hood for an infrared temperature sensor according to a preferred embodiment of the present invention; and

Like reference numerals refer to like parts throughout the various views of the drawings.

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Hence, specific dimensions and other physical characteristics relating to the embodiments disclosed herein are not to be considered as limiting, unless the claims expressly state otherwise. Also, it should be noted that a wire, electrical contact, electrical connector, etc., could be used as the form of electrical communication between internal device components.

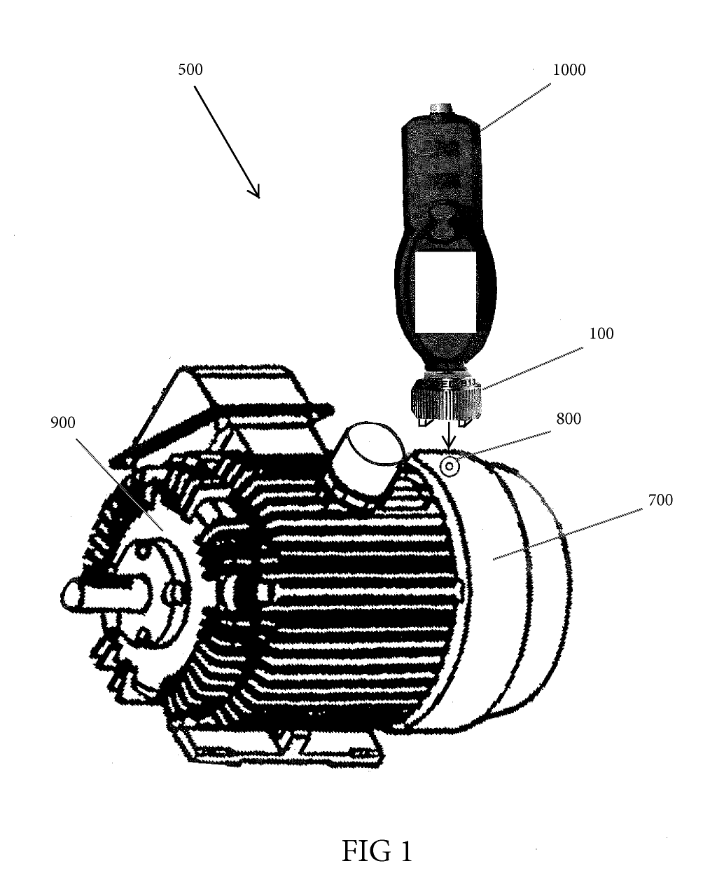

For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims.

A sensing system 500 that provides a temperature sensory head 100 which is in electro-mechanical communication with a mobile data collector 1000 is illustrated in FIG. 1. The temperature sensory head 100 senses a temperature of and transmits vibration emitted from a machine housing 700 having an RFID tag 800 disposed thereon. The machine housing could also be a bearing housing and be in mechanical communication with a piece of rotating equipment 900.

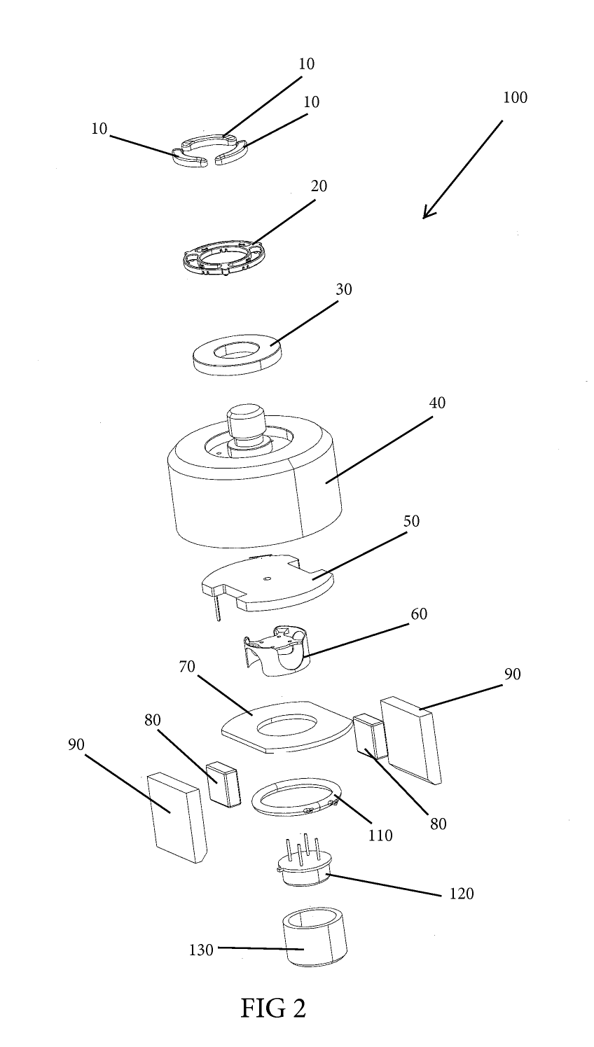

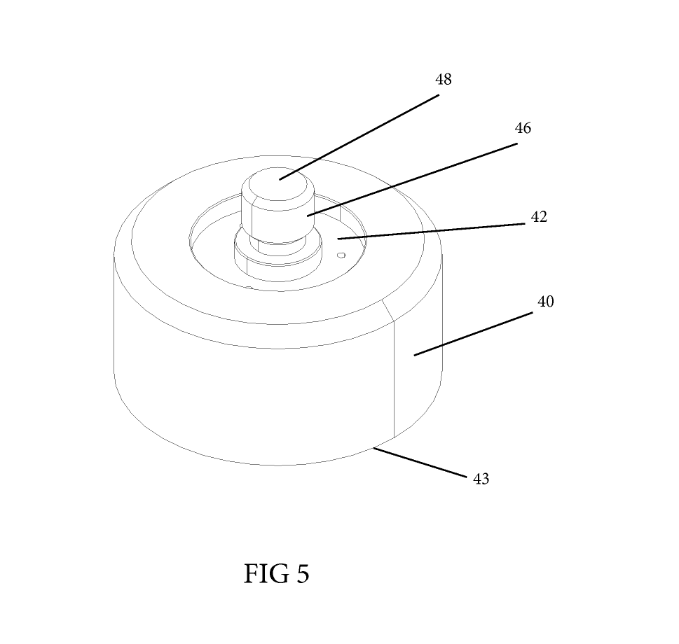

An exploded view of the sensory head 100 and its components is illustrated in FIG. 2. The device 100 includes a body shell 40 for housing the sensory head 100 and a threaded stud 46 for mounting the device. A system ground connection 48 is integrated into the mounting stud 46 of the body shell 40. See now FIGS. 2 and 5. The mobile data collector 1000 includes a corresponding female threaded recess. On assembly, the threaded stud 46 of the sensory head 100 is screwed into the female threaded recess of the mobile data collector 1000 until the threads stop.

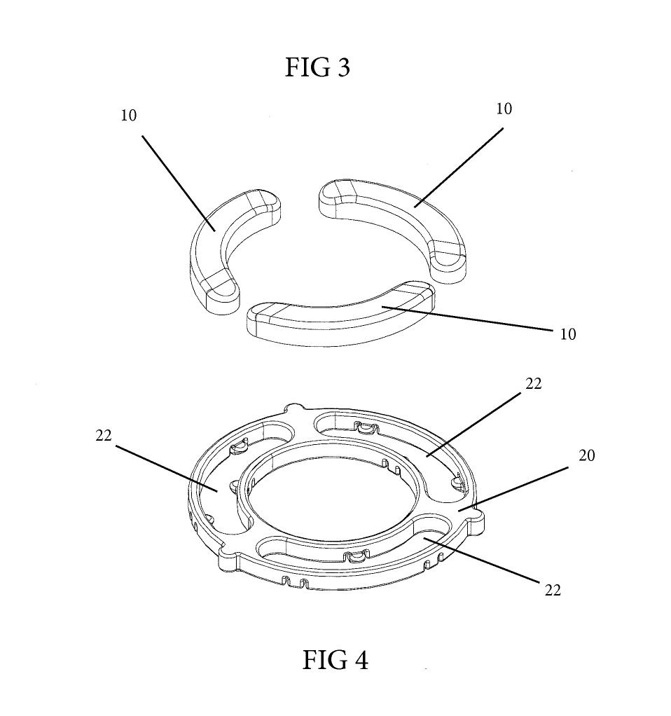

At least one contact 10 for delivering power to the sensory head 100 and for providing at least one of a digital Input signal into the device 100 and a digital output signal out of the sensory head 100 are illustrated in FIGS. 2-4 (digital I/O signal). In this embodiment, the device provides three individual contacts 10. As such, the at least one digital input, digital output and power contact 10 further provides three semi-circular contact rings 10 disposed within semi-circular recesses 22 disposed within isolator body 20. The isolator body 20 separates the three semi-circular contact rings 10 from coming into contact with each other. The isolator body 20 and three semi-circular rings 10 are potted into an annular recess 42 disposed within the shell body 40 with a resin 30 for strength. As can be seen, top and side portions of the contacts are still exposed. As such, when the mobile data collector 1000 and sensory head 100 are screwed together the three contacts 10 come into contact with a corresponding set of three contacts disposed thereon on the mobile data collector 1000. The sets of threads are positioned so that the contacts properly align with each other and do not short out when the threads stop and assembly is complete. In an alternate embodiment, the at least one contact ring may provide four semi-circular contact rings 10. In this embodiment, the four contacts could support electrical communication for power, a digital input line, a digital output line and an antenna connection.

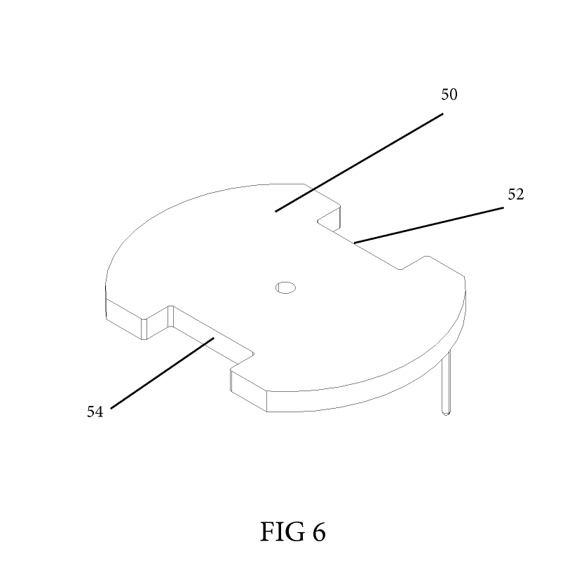

As illustrated in FIGS. 2 and 6, the device 100 also provides a combination power and control circuit 50 for powering the control circuit and for controlling function of the sensory head 100. The combination power and control circuit 50 is in electrical communication with the at least one contact 10. Here, the combination power and control circuit may be provided in the form of a printed circuit board or PCB.

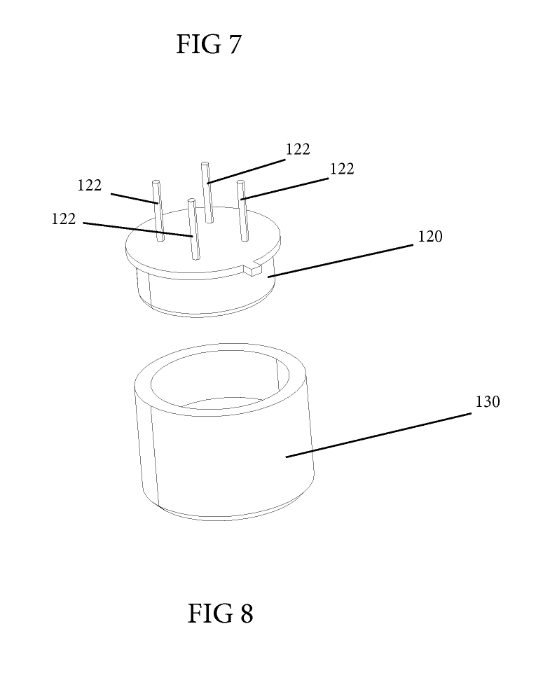

An infrared temperature sensor 120 for measuring the sensed temperature of the machine housing is further provided and is illustrated in FIG. 2. The infrared temperature sensor 120 is in electrical communication with the PCB 50. The infrared temperature sensor 120 has a hood 130 that shields the infrared temperature sensor 120 from outside elements. The sensory head includes an infrared/antenna spacer 60 for mounting and locating the infrared sensor 120 and sensor hood 130 within the device body 40. See now FIGS. 2, 7-8.

Here, the invention contemplates that the machine or bearing housing 700 already has an RFID tag 800 disposed thereon. The RFID tag 800 provides a unique identifier for the piece of machinery or asset in an inventory of equipment. In order to link a specific asset with its sensed temperature and vibration emissions, the device provides an RFID antenna 110 supplied in the form of a tuned loop of wire. As such, the RFID antenna reads the RFID tag attached to the machine housing and enables transmission of the unique tag identification into the mobile data collector 1000.

The RFID antenna could also be an RFID spiral antenna or a wound inductor antenna mounted on an antenna plate 70. Here, the RFID antenna 110 is in electrical communication with the PCB 50 via leads 122, which in turn is in electrical communication with at least one of the contacts 10. As previously disclosed, the at least one contact transmits the read tag information through a digital output signal and out of the sensory head 100 into the mobile data collector 1000. To provide structure, the antenna 110 and mounting plate 70 are potted with a resin that protects and secures the antenna within the body shell 40 of the sensory head 100. The resin does not extend beyond a base 43 of the body shell 40.

The sensory head 100 includes at least one magnet 80 that is used to magnetically attach the sensory head 100 to the machine housing. In this embodiment, the at least one magnet 80 provides two magnets. The two magnets get inserted into slots 52, 54 that are disposed within the PCB 50. The sensory head 100 further has at least one mounting foot 90 that is fabricated from a high permeability material. The at least one magnetic foot 90 transmits the magnetic flux emitted from the at least one magnet 80 to the machine housing 700. It should be understood that the at least one magnet and at least one mounting foot could be provided in any shape or size that fits the application and not limited to what is necessarily illustrated.

When the sensory head 100 is magnetically attached to the machine housing 700, transmission of machinery vibration from the machine housing through the sensory head to the mobile data collector 1000 is enabled. When the sensory head 100 is installed proximate to the RFID tag 800, the infrared temperature sensor 120 takes a temperature measurement of the machine housing and enables transmission to the mobile data collector 1000.

1. A sensory head 100 for sensing the temperature and vibration emitted from a machine housing having an RFID tag disposed thereon, the sensory head comprising;
a body 40 for housing the sensory head 100;
at least one digital input/output power contact 10 for delivering power to the sensory head 100 and for providing at least one of a digital Input signal into the device 100 and a digital output signal out of the sensory head 100;
a combination power and control circuit 50 for powering the control circuit and for controlling function of the sensory head 100, the combination power and control circuit 50 in electrical communication with the at least one contact 10;
an infrared temperature sensor 120 for measuring the sensed temperature of the machine housing, the infrared temperature sensor 120 in electrical communication with the combination power and control circuit 50;
an RFID antenna 110 for reading and identifying the RFID tag attached to the machine housing, the RFID antenna 110 electrically connected with the with the combination power and control circuit 50;
at least one magnet 80 for magnetically attaching the sensory head 100 to the machine housing; wherein
transmission of machinery vibration from the machine housing through the sensory head is enabled when the sensory head is magnetically attached to the machine housing, and wherein
the infrared temperature sensor 120 takes a temperature measurement of the machine housing when the sensory head is installed proximate to the RFID tag.

2. The sensory head according to claim 1, wherein the body 40 further comprises a threaded stud 46 for mounting the device.

3. The sensory head according to claim 2, further comprises a system ground connection 48 integrated into the mounting stud 46.

4. The sensory head according to claim 1, further comprising at least one mounting foot 90 for transmitting the magnetic flux emitted from the at least one magnet 80 to the machine housing, the magnetic foot being fabricated from a high permeability material.

5. The sensory head according to claim 1, wherein the RFID antenna further comprises one of an RFID spiral antenna or a wound inductor antenna mounted on an antenna plate 70.

6. The sensory head according to claim 5, further comprising at least one RFID antenna connection (112, 114) that connects the RFID antenna through antenna plate 70 to the combination power and control circuit 50.

7. The sensory head according to claim 1, wherein the antenna 110 and mounting plate 70 are covered with a resin that protects and secures the antenna with the sensory head 100, the resin not extending beyond a base 43 of the device body 40.

8. The sensory head according to claim 1, wherein the infrared temperature sensor 120 further comprises a hood 130 that shields the infrared temperature sensor 120.

9. The sensory head according to claim 8, further comprising an infrared/antenna spacer 60 for mounting and locating the infrared sensor 120 and sensor hood 130 within the device body 40.

10. The sensory head according to claim 1, wherein the at least one digital input, digital output and power contact further comprises three semi-circular contact rings and an isolator body, the isolator body separating the three semi-circular contact rings from coming into contact with each other, the isolator body and three semi-circular rings being potted with a resin.

11. The sensory head according to claim 1, wherein the combination power and control circuit is a printed circuit board (PCB).

12. The sensory head according to claim 11, wherein the device ground is in electrical communication with the printed circuit board.

13. The sensory head according to claim 12, wherein the at least one magnet further comprises two magnets that insert into slots disposed within the printed circuit board.

14. The sensory head according to claim 1, wherein the machine housing further comprises a bearing housing.

15. A sensing system providing a temperature sensory head in electro-mechanical communication with a mobile data collector, the temperature sensory head for sensing the temperature of a machine housing having an RFID tag disposed thereon, the temperature sensory head comprises;
a body for housing the device, the body having a threaded recess for mounting, the threaded recess for providing electro mechanical communication to and from the device;
a digital input/output power contact for delivering power to the device and for providing digital I/O signal communication into and out of the device;
a combination power and control circuit for powering the control circuit and for controlling function of the device;
an infrared temperature sensor for measuring the sensed temperature of the machine or bearing housing;
an RFID antenna for reading and identifying the RFID tag attached to the machine or bearing housing;
a magnet for magnetically attaching the device to the machine or bearing housing;
the mobile data collector comprising:
a threaded stud for mounting the threaded recess of the temperature sensory head to the mobile data collector; and wherein
when the device is installed proximate the RFID tag the device initiates an infrared sensor measurement of the bearing housing and transmits the measurement back to the mobile data collector for processing.

16. A temperature and vibration sensing system including a sensory head in electro-mechanical communication with a mobile data collector, the sensory head for sensing the temperature of and vibration emitted from a machine housing having an RFID tag disposed thereon, the sensory head comprises;
a body for housing the device, the body having a threaded recess for mounting, the threaded recess for providing electro mechanical communication to and from the device;
a digital input/output power contact for delivering power to the device and for providing digital I/O signal communication into and out of the device;
a combination power and control circuit for powering the control circuit and for controlling function of the device;
an infrared temperature sensor for measuring the sensed temperature of the machine or bearing housing;
an RFID antenna for reading and identifying the RFID tag attached to the machine or bearing housing;
a magnet for magnetically attaching the device to the machine or bearing housing;
the mobile data collector comprising:
a threaded stud for mounting the threaded recess of the temperature sensory head to the mobile data collector; and wherein
when the device is installed proximate the RFID tag the device initiates an infrared sensor measurement of the bearing housing and transmits the measurement back to the mobile data collector for processing.

17. The temperature and vibration sensing system according to claim 16, wherein the at least one contact ring further provides four semi-circular contact rings 10, and wherein the four contact rings support electrical communication for the power, the digital input/output and an antenna connection.
